(19) United States
(12) Patent Application Publication
(10) Pub. No.: US 2002/0109794 A1
(43) Pub. Date: Aug. 15, 2002

(54) Display screen aspect ratio adjusting mask assembly and method

(76) Inventor: Barry R. Bergman, Chicago, IL (US)

Correspondence Address: James W. Potthast, Potthast & Associates, 2712 N. Ashland Avenue, Chicago, IL, 60614-1106, US

(21) Appl. No.: 09/828,364

(22) Filed: Apr. 7, 2001

Related U.S. Application Data
(60) Provisional application No. 60/240,864, filed on Oct. 13, 2000.

(51) Int. Cl. H04N 5/64

(52) U.S. Cl. 348/841

(57) ABSTRACT

A mask assembly (46) for masking the non-active portions (24, 26) of a display screen (12) when showing a picture (14) in letterbox format has a pair of felt mask members (48, 50) that are transparent to infrared remote control signals (60) to enable receipt of the remote control signals by a remote control sensor (40) even though covered by the mask member (48, 50). The mask members are removably mounted to a display screen housing (36) by means of VELCRO-like fasteners attaching opposed end portions (76, 78) to vertical frame mounting members (66, 68) that, in turn, are semi-permanently attached to the display screen housing (36) by adhesive. The adhesive is hidden from view by the vertical frame members that are located adjacent to the sides of the display screen (12) to form a rectangular frame around the letterbox picture (14) and the vertical frame mounting members (66, 68) have an appearance like that of the mask members to produce a rectangular frame of uniform appearance without transverse mounting tabs or the like. Alternatively, the vertical frame mounting members are attached to the display screen housing (36) by a vertical loop (FIGS. 4, 5 and 86, 88, 93) surrounding the housing (36), by fasteners at the back of the housing adjacent the top (89, 91) or by means of counterweights (87), or are eliminated entirely and the mask members (48, 50) mounted to the housing (36) by means of a horizontal mounting loop (FIGS. 6, 7 and (94, 96, 98, 100).

### CROSS-REFERENCE TO RELATED APPLICATION

This application claims under 35 U.S.C. 119(e) the benefit of U.S. Provisional Application No. 60/240,864, filed Oct. 13, 2000 by the present inventor and entitled “Tview”.

### BACKGROUND OF THE INVENTION

1. Field of the Invention

This invention relates generally to apparatus to mask non-active portions of a display screen that are not carrying any portion of the image being displayed, and more particularly, to such a mask that is adjustably and releasably attachable to televisions of different size.

2. Discussion of the Prior Art

In the film rental and purchase industry videotape, laser disc, and DVD (digital videodisc) formats are used to transfer commercial films to home entertainment recordings. These film-purchase and film-rental markets form a large portion of the film business that exists today. Most films that are shown in movie theaters are later released on videotape, laser disc, and DVD to realize further profits.

Most current films are shot in a wide-screen, or 70 mm, format. One such wide-screen format is called CINEMASCOPE ® and generally the format is sometimes referred to as “letterbox” format. Consequently, a problem arises when it is desired to display a wide-screen film on the screen of a television, monitor or other moving picture screen that does not have a wide screen aspect ratio. The problem is that the wide-screen picture has approximately a 2:1 (horizontal: vertical) aspect ratio while a conventional home television or like display screen has approximately a 4:3 aspect ratio.

Sometimes wide-screen movies are cropped when transferred to video, video disc or DVD in order to fill the entire screen, but this, of course, excludes from viewing the portions of the picture adjacent to the opposed lateral sides of the screen. Other times the video picture is shortened in width so all of the picture is contained within the screen and none is left out as occurs with cropping, but this distorts the picture and makes everything look relatively thinner and taller. This is often necessary to do even with pictures that have been cropped generally when displaying the credits for the film or other program that extend across the entire picture and thus could not be read if cropped.

Alternatively, neither cropping nor foreshortening is performed during the transfer to videotape, DVD, or laser disc. Instead, the transfer is made in the original wide-screen format, or “letterbox” format. When a picture is transferred to recording medium in letterbox format the entire wide-screen film is transferred to the videotape, DVD, or laser disc in its original aspect ratio. Consumer viewing in this format is preferred by many because no portion of the picture is cropped out and no portion is distorted. As a result, the consumer can view the film exactly as it appeared in the movie theater.

However, there are two problems or disadvantages with viewing letterbox dimensioned film on a display screen that is not itself letterbox dimensioned. The size of the picture is reduced vertically relative to the vertical dimension of the display screen in order to display the entire width of the film. Because of the different aspect ratios, there is a non-active portion of the display screen above the letterbox sized active portion bearing the picture and another one beneath the letterbox sized active portion of the display screen. The picture is displayed between these two inactive portions of the screen.

The non active-portions are generally black and appear as two black bars above and below the picture. A problem with these inactive portions is that because they are not being backlit by the picture but remain black, these inactive portions of the screen become highly reflective darkened mirrors. Consequently, these non-active portions strongly reflect back to the viewer ambient light from the room in which the display screen is located in the form of glare and other distracting reflections. In addition, even when the room is dark to eliminate such glare, the black non-active portions remain reflective such that the edges of the intermediate picture blend into the bars, particularly when dark or dim pictures are being displayed adjacent the black non-active portions.

Consequently, many viewers of videotape, DVDs and laser discs desire the letterbox version of a film but find the black bars annoying, visually disconcerting and viewing pleasure reduced. Some attempts have been made that address these problems but they are less than entirely satisfactory.

In U.S. Pat. No. 2,751,583 a solid, inflexible opaque shutter is built into the chassis. The opaque shutter may be raised or lowered using a gear arrangement to selectively cover an auxiliary bottom portion of the screen viewing opening. The shutter is made of opaque glass, plastic or the like and, as indicated, is only capable of selectively covering a portion of the bottom of the screen. Because of the material used, the shutter may be as reflective as is the screen itself. In addition, the complicated structure and method of mounting and adjusting prevents it from easily being mounted to different sized televisions and is relatively expensive in terms of material and assembly.

In U.S. Pat. No. 4,556,906 a bezel or mask in the shape of a rectangle is used to cover a non-active area of a television screen, but when a different aspect ratio is desired, then a different bezel or mask is required. The material of bezel is indeterminate but appears to be rigid and nonadjustable.

Some of these problems are overcome with an adjustable television mask shown in U.S. Pat. No. 5,175,627 issued Dec. 29, 1992, to Josephs. This mask, however, requires four separate pieces that must be assembled in order to cover inactive portions that appear only at the top and bottom and is therefore unduly complicated. The four pieces are L-shaped and must be simultaneously overlapped in two different directions and at locations adjacent to the middle portions of both the opposite lateral sides. This results in a double thickness of the pieces at these middle locations. In addition, the mask material is made of semi-flexible plastic or the like, which is presumably reflective, or of rigid cardboard or heavy paper stock that is non-rollable and relatively non-durable. Alternatively, each component is magnetized, is made of adherent plastic or carries an adhesive material to hold the pieces together.

In addition, the four pieces of the frame are attached to the television chassis by means of VELCRO fasteners in which one of the component parts must be apparently relatively permanently attached to the sides of the television chassis by means of adhesive or the like. Disadvantageously, these fasteners stick out from the side of the mask in direction outside of the plane of the display screen and the four pieces of the mask assembly and are unsightly.

As noted, another characteristic of the material used by all of the above framing devices is that the frame members are entirely opaque which as will be explained below can lead to another disadvantage.

### SUMMARY OF THE INVENTION

In accordance with the objective of the present invention the disadvantages and other problems with the known masking systems and methods noted above are overcome.

This objective is achieved in part by providing an adjustable mask assembly for masking an inactive portion of display screen with non-letterbox dimensions when showing a program in letterbox format composed of a masking member for covering the inactive portion of the display screen and capable of passing remote control signals for controlling the operation of the display and means for removably mounting the infrared remote control signal passing masking member to the display screen to mask the inactive portion of the display screen. Advantageously, in accordance with this aspect of the invention, the use of the mask, even if it covers a remote control sensor, will not interfere with the remote control operation, and can be mounted to the display screen without concern for the location of the infrared remote control sensor.

Thus, the maximum benefit of this aspect of the invention is obtained when the display screen is part of a display screen assembly that includes a remote control sensor responsive to remote control light signals and a circuit responding to remote control light signals sensed by the remote control sensor, and the masking member has at least a part that is sufficiently transparent to remote control light signals to enable such remote control signals to pass through the masking member to be sensed by the remote control signal sensor, and means for mounting the at least part of the masking member in a position overlying the remote control sensor.

The masking member is sufficiently transparent to remote control signals to enable sensing by the remote control sensor of infrared signals that pass through the mask but the mask appears relatively visually opaque, particularly when backed by the black bars of the non-active portion of the display screen. Preferably, the mask member, or at least the portion of the mask member that overlies the remote control sensor, is made of flexible opaque material with a myriad of small openings that are relatively invisible to normal unaided observation by viewers of the display when the part is backed against a dark surface of an inactive portion of the display screen but through which the infrared signals may pass. Preferably, the flexible material is felt of a sufficient weight to be self-supporting when held upright at opposed ends but with sufficient transparency to allow the passage of the infrared remote control signals. A 6.0 inches wide, 60 inches long, and 1/16^{th} inch thick piece of felt with a weight of 5 ounces per square yard has been found to work satisfactorily.

The objective is also obtained in part by provision of an adjustable mask assembly for masking an inactive portion of a display screen of non-letterbox dimension when showing a program in letterbox format and being mounted within a display screen housing having a pair of opposite sides extending between a bottom and a top, with an elongate masking member for covering the inactive portion of the display screen having a body extending between a pair of opposite ends, a pair of elongate vertical frame mounting members mounted adjacent to and generally parallel to the pair of opposite sides of the display screen housing, respectively, each of the vertical frame mounting members having an elongate frame body that spans the entire side of the display screen and carrying means for attachment of the body to the display screen housing, said attachment means being covered from view by the body when attached to the display screen body, and means for mounting the opposite ends of the elongate masking member to the pair of vertical frame members with the body extending across the display screen in a position to mask the inactive portion of the screen.

The objective is also achieved in part by providing an adjustable mask assembly for masking an inactive portion of a display screen of non-letterbox dimension when showing a program in letterbox format and being mounted within a display screen housing having a pair of sides extending between a top adjacent and parallel to a pair of opposite sides of the display screen and a bottom, with a pair of elongate frame mounting members attached to the display screen housing by a vertical loop surrounding the display screen housing from top to bottom with a frame body located adjacent to an parallel to the pair of sides of the display screen, means carried by the body of each of the pair of elongate frame mounting members for releasable connection with an end portion of a horizontal mask member, and a pair of horizontal mask members with a pair of opposed end portions having releasable connectors for releasable connection with releasable connection means of the elongate frame mounting members for support of the horizontal mask member in a position to mask an inactive portion of the display screen.

Also, the objective is obtained by providing an adjustable mask assembly for masking an inactive portion of a display screen of non-letterbox dimension when showing a program in letterbox format and being mounted within a display screen housing having a pair of sides extending between a top adjacent and parallel to a pair of opposite sides of the display screen and a bottom, having a pair of horizontal mask members for masking a pair of inactive portion of the display screen, and means for mounting the mask member to the display screen housing including means connected to opposite ends of the horizontal mask members to form a horizontal loop around the display screen housing. Preferably, the horizontal loop is formed by means including a resilient member.

The objective of the invention is also obtained in part by providing a method of watching a program displayed in letterbox dimensions on a display screen having non-letterbox dimensions and a remote control sensor and circuit responsive to signals received at the remote control sensor to control one or more functions associated with the display screen, by performing the steps of mounting an infrared remote control transparent but relatively visually opaque mask member to the display screen to cover a non-active portion of the screen and the remote control sensor, blocking substantially all reflective light from the non-active portion of the screen with the visually opaque mask member, remotely controlling the display screen with infrared remote control signals that pass through the mask member to the remote control sensor.

Moreover, the object of the invention is partly obtained by providing a method of masking the non-active portions of a display screen of non-letter box dimensions when displaying a letterbox dimensioned program, by performance of the steps of mounting a pair of elongate, generally rectangular, vertical mounting frame members adjacent to and parallel to opposite sides of the display screen but not overlying any portion of the display screen by means that is covered by to define vertical frame members for the display screen from at least the top to the bottom of the display screen, and mounting a pair of mask members to span horizontally across the display screen by attaching opposed ends of the mask members to the pair of vertical mounting frame members, respectively, to cover upper and lower non-active portions of the display screen and defining horizontal frame members for the screen.

Preferably, the mask members are selectively cut to terminate at the juncture with the mounting frame members after the mask members are mounted, and the vertical mounting members are made of substantially the same material as that of the mask members to provide a uniform appearance.

### BRIEF DESCRIPTION OF THE DRAWINGS

The foregoing advantageous features will be described in detail and further advantageous features will be made apparent from the detailed description of the preferred embodiment that is given with reference to the several figures of the drawings, in which:

FIG. 1 is a front view of a PRIOR ART conventional (i.e. not wide-screen) television with a display screen showing a letterbox picture on an active portion of the screen, the location of the non-active “black bar” portions of the display screen and the exemplary locations of a remote control sensor;

FIG. 2 is a front elevation view of the television of FIG. 1 but with one form of the mask assembly of the present invention attached to the television to mask the non-active portion of the display screen;

FIG. 3 is an enlarged sectional side elevation view of a cutout portion of upper left had corner of the television and mask assembly of FIG. 2;

FIG. 4 is a front elevation view of the television of FIG. 1 but with another form of the mask assembly of the present invention attached to the television to mask the non-active portion of the display screen in which the vertical mounting members 66 and 68 are removably mounted to the display screen housing by vertical attaching members looped vertically around or otherwise mounted to the display screen housing;

FIG. 5 is a side elevation view of the television and mask assembly of FIG. 4 and showing alternative techniques for removable mounting techniques for mounting the vertical mounting members 66 and 68;

FIG. 6 is a front elevation view of the television of FIG. 1 but with yet another form of the mask assembly of the invention in which the vertical frame mounting members of FIGS. 2 and 4 have been eliminated, and the mask members are mounted to the display screen by attachment members looped horizontally around the display screen housing;

FIG. 7 is a side elevation view of the television and mask assembly of FIG. 6; and

FIG. 8 is a plan view of an alternative form of the mask member used in the embodiments of FIGS. 2-6. [Show here any alternative forms contemplated]

### DETAILED DESCRIPTION

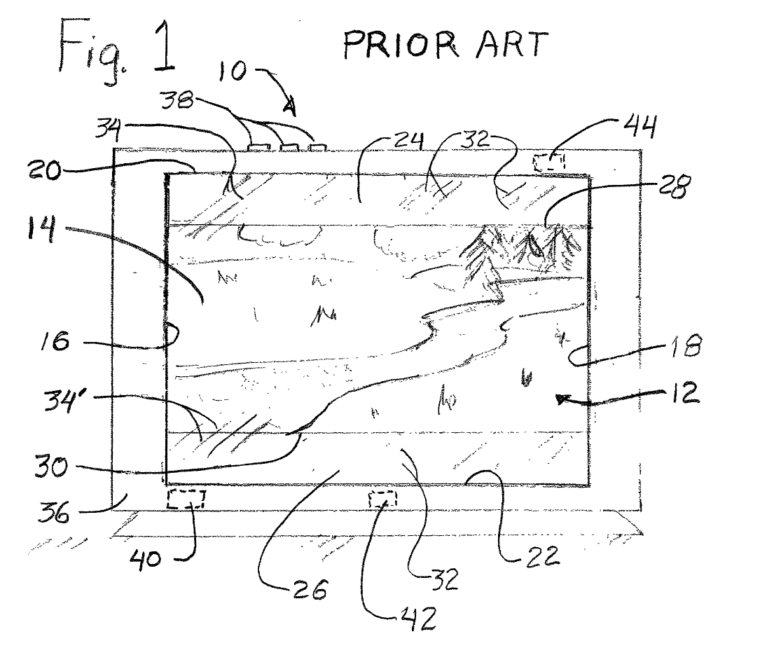

Referring now to FIG. 1, a prior art conventional television, monitor or other conventional display apparatus 10 is seen to have a display screen 12 with a non-wide-screen, non-letterbox dimensioned display screen 12 that has an aspect ration of 4:3 (horizontal to vertical) that is showing a video picture 14 in wide-screen format, or “letterbox” format, that has an aspect ratio of 2:1 or 6:3. The opposite sides of the letterbox picture 14 coincide with the opposite sides of the display screen, left side 16 and right side 18. However, in order to “squeeze” the wide-screen into the distance between the screen sides 16 and 18 while keeping the same ratio of vertical to horizontal sizing as in the original film, it is necessary to foreshorten the letterbox picture in the vertical direction relative to the top 20 and the bottom 22 of the display screen. Consequently, there is created a top non-active portion 24 and a bottom non-active portion 26.

The top non-active portion 22 appears as a black bar at the top 28 of the picture 14, between the top 28 of the letterbox picture 14 and the top 20 of the display screen. The bottom non-active portion 26 appears as a black bar at the bottom of the letterbox picture 14, between the bottom 30 of the picture and the bottom 22 of the display screen 12. As illustrated by the glare lines 32, the upper and lower non-active portions of the display screen 12, like the remainder of the screen 12, is made of glass, transparent plastic or the like, having a smooth, high-gloss finish, that is highly reflective of ambient light when not backlit. As illustrated by glare lines 34′ when a part of a picture contiguous with the bottom 30 or the top 28 of the picture is also temporarily dark, or not backlit, as a natural consequence of the picture being displayed, such as a night seen with a dark night sky in the background or a flowing river in the foreground, the contiguous portions becomes reflective to the same degree, or almost to the same degree, as the non-active portions 24 and 26. Consequently, adjacent active portions visually look similar to the non-active dark portions and visually merge into the non-active dark portions. This visual merging caused by the highly reflective surface of the display screen 12 prevents the non-active portions, or black bars, 24 and 26, from being effective “frames” for the top 28 and the bottom 30, even though they are appropriately “black”.

Still referring to FIG. 1, the television, monitor or other display 10 include a display screen housing 36 within which the display screen 12 and the circuitry needed for the operation of the display screen 12 are mounted. Manual control switches 38 for volume level, power and channel selection are provided at the top of the display screen housing 36, but in modern televisions, the televisions are controlled remotely. An infrared remote controller (not shown) transmits remote control infrared light signals 60 that are outside of the visible spectrum but which are sensed by a remote control sensor 40 mounted to the face of the housing 36. The remote control sensor 40 is located on the face of the housing 36 such as the location of remote control sensor 40. Alternatively, the remote control sensor is mounted at other locations such as remote control locations 40′ and 40″. It should be appreciated that although the locations of the remote control sensor are clearly indicated in FIG. 1, the actual sensors can be quite small, their location may be hidden behind a speaker grill or the like and thus their location is not always visually apparent to the user.

Referring now to FIG. 2, a preferred embodiment of the adjustable mask assembly 46 of the invention is seen being used to mask the inactive portions 24 and 26 of the display screen 12 of FIG. 1 when the display screen 12 is showing a picture 14 in letterbox format. As seen, it includes a pair of horizontally mounted masking member 48 and 50 for respectively covering the inactive portions 24 and 26 of the display screen 12. Each of the masking members 48 and 50 are substantially identical and are interchangeable. While the masking members can be made in different sizes for different sized display screens 12, it has been determined that if masking members 48 and 50 are made 60 inches long and 6 inches wide, they will be of sufficient size to cover even the non-active portions of most of the largest televisions, or display screens. For display screens smaller than the largest screen, the masking members are made of workable material that can be cut to size if desired.

In keeping with an important aspect of the invention, the mask member 48 and 50 are made of a material that is sufficiently capable of transmitting infrared remote control signals even though the mask member that may cover the remote control sensor 40 at any of the locations at which the sensor 40 may be located, as shown in FIG. 2, to enable the remote control operation to still function properly This circumstance enables manufacturing the adjustable mask assembly 46 in one-size-fits-all size without concern for the location of the remote control sensors relative to the location of the mask members 48 and 50.

At the same time, the mask members 48 and 50 are transparent to infrared remote control signals, they are visually dark in color, preferably black, and visually appear opaque and non-transparent and non-reflective to light in the visible spectrum. The mask members preferably have “flat”, light-scattering, surfaces, rather than high-gloss, shiny reflective surfaces that will reflect ambient light back to the viewer. While, in fact, the actual material may be natural such as cloth felt, it may also be synthetic material, such as non-shiny plastic, so long as it has a structure or characteristic that enables the passage of infrared remote control light signals through a mask made from the material while at the same time not appearing transparent or reflective to the viewer. There may be small linear openings through the mask members such that if backlit one would see light passing through the mask, and, in fact, this is the case with respect the cloth felt specified herein. However, this infrared signal transparency does not interfere with the masking function, because the mask member is only backed by a non-active portion, and therefore a dark or “black”, portion of the display screen, and thus there is no back-light during use of the mask.

In addition, to being capable of transmitting infrared remote control signals, it is important that the material has sufficient structural integrity so that when supported in an upright orientation suspended across the display screen 12 from connections at the opposite ends, it does not swing away from the display screen 12 or droop downwardly into the active portion of the display screen but, instead, maintains a substantially straight and upright configuration. At the same time the mask members must be sufficiently flexible to fold or roll for storage and shipping. In addition, the material used for the masks 48 and 50 is also preferably capable of withstanding the heat generated by a television over long periods of time without deterioration and be odorless, hypoallergenic, environmentally inert and safe. Moreover, the material should be sufficiently workable to enable cutting and shaping it with a regular pair of scissors to size, if desired to eliminate any excess portion when mounted on a display screen of a size less than the maximum size on which the mask assembly can be used. There should be no small parts that can be easily separated from the masks or from any other part of the mask assembly 46 that can be swallowed or lost.

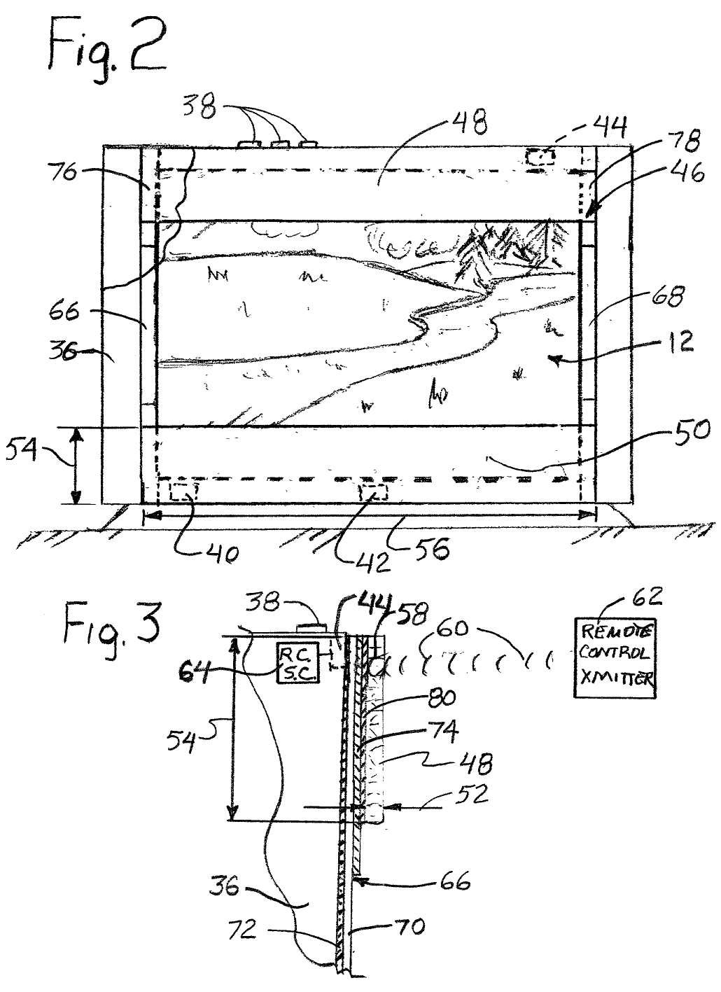

Referring also to FIG. 3, while other material may be used, the present inventor has discovered a material that meets all these criteria and is preferred: sized natural cloth felt. Preferably, the masks 48 and 50 are each made entirely of a piece of natural cloth felt having a weight, or density of 5-ounces per square yard, a thickness 52 of 1/16^{th} inch, a width 54 of 6-inches and a length 56 of 60-inches. Such felt is commercially available cut to size and a mask of this material can be easily made and acquired. Advantageously, the cloth felt of this density has naturally occurring, small, or pin-hole sized, openings 58, passing entirely through the thickness 52 of the mask members 48 and 50 and a rough, non-reflective surface as a natural consequence of how cloth felt is manufactured. In addition, a piece of felt of these preferred specifications has sufficient structural integrity to maintain its shape and a neat linear appearance even after being heated, while still being sufficiently flexible, or pliable, to be folded or rolled for shipping and storage. Preferably, the felt is black or charcoal gray or the like although felt of other colors can be obtained and could be successfully employed. In addition the cloth felt can easily be cut to size. Other naturally occurring material could be other heavily woven cloth or other cloth that has been sized or otherwise treated to give it sufficient structural strength to be self-supporting when suspended across a screen so as not to droop.

While an integral single piece of cloth felt as described above is the preferred form of the masks 48 and 50, the masks 48 and 50 could also be made of a transparent plastic with a cheese cloth or sponge-like material adhered to the outer surface. A non-reflective rubber-like or plastic-like material in which small infrared light-transmitting pinholes have been added mechanically or by means of a molding process could also possibly be employed. Other structures and other materials that meet the above functional criteria can also be employed.

For instance, in lieu of openings for the passage of light the material itself may simply be transparent plastic or the like that has an outside surface that is non-reflective or at least less reflective than the non-active portion of the display screen, itself, and is sufficiently light absorbent in the visible spectrum to appear relatively opaque and non-reflective of ambient light. Such materials could include translucent and flexible forms of polystyrene, polypropylene or the like. However, they would need all the qualities and characteristics noted above and achieved with the specified felt cloth, noted above.

In any event, the mask members 48 and 50, even though being in a position to cover the infrared remote control sensor 40 or the other likely control sensor locations 42 and 44, are sufficiently transparent to infrared remote control light signals 60 from a remote control transmitter 62 to enable the infrared light to pass through the mask members 48 and 50 to impinge upon the remote control sensor, such as remote control sensor 44. As shown in FIG. 3, this enables a remote control sensor circuit 64 to respond to the remote control light signals 60 sensed by the remote control sensor 44 to control the operating functions of the display screen 12. Thus, the mask members 48 and 50 may be mounted to the display screen 12 and the display screen housing 36 without concern for the location of the remote control sensors. Still referring to FIGS. 2 and 3, the pair of mask members 48 and 50 is removably and adjustably mounted in the desired position overlying the non-active portions 24 and 26 of the display screen 12 when a letterbox picture is being displayed. When a letterbox picture 14 is not being displayed then the mask members 48 and 50 may be removed to enable viewing of the entire display screen. A pair of relatively narrower, elongate, substantially identical vertical frame mounting members 66 and 68 is mounted adjacent to and parallel to the pair of opposites sides 16 and 18 of the display screen 12. In accordance with one aspect of the invention the vertical frame mounting members have a length sufficient to span the display screen 12 from top 20 to bottom 22 to provide a vertical frame between the mask members 48 and 50 to form a continuous rectangular frame around the entire letterbox picture 14. The vertical frame mounting member 66 and 68 perform a dual function of both providing the only means by which the mask members 48 and 50 are mounted to the display screen and also providing vertical frame elements without the unsightly appearance of mounting tabs extending laterally outwardly or crosswise from the frame. mounting member 66 and 68 is removed. Alternatively, the attaching means is a permanent magnetic flexible coating that will removably attach to the housing by means of magnetic force, although this is not preferred because of many housings today not being magnetically attractive. Preferably, but not necessarily, the attaching means 70 extends continuously along the entire length of the body 70 to insure a snug attachment along the entire length of the body 70.

In keeping with one aspect of the invention, the vertical mounting members 66 and 68 are attached to the housing 36 adjacent, and preferably contiguous with, the sides 16 and 18, respectively, of the display screen 12 and are therefore entirely in parallel relationship with the sides of the 16 and 18. In this location they function as side frame elements in addition to being the means for enabling the adjustable and removable mounting of the mask members 48 and 50. In fact, one of the advantageous features of the invention is that all of the elements of the mask assembly are parallel to one of the sides of the housing 36 and all the elements generally lie in a plane that is parallel to the display screen 12 to provide a visually attractive appearance. Accordingly, there is no need for attachment tabs or other attachment members that do not also function as frame members or which extend transversely to the frame members and to the common plane in which they lie.

Releasable mask connection means 74 is carried on the front of the body 70 of the vertical mounting members 66 and 68 for releasable connection with an opposite end portions 76 and 78 of the horizontal mask members 48 and 50. The inside surfaces of the end portions 76 and 78 also preferably carry mating releasable connection means 80. Preferably, the releasable connection means is a VELCRO-like fastener array. In such case, then the mating releasable connection means 80 is preferably a mating VELCRO-like fastener array, such as an array of loop-type connectors that mate with the hook-type connectors to releasably and adjustably attach the end portions 76 and 78 of the mask members 48 and 50 to the display screen housing 36. Alternatively, the other types mating fasteners are used such as resilient snap fasteners, non-drying adhesive fasteners or the like. The connector 80 has a length extending from the ends at least equal to the width 54 of the mask members 48 and 50 In accordance with the method of the present invention, the mask assembly is made in only one size, but the material are workable so that all the elements are cut to size to form a perfect rectangle appropriate for the size of the particular television on which it is going to be used permanently, if needed. Accordingly, if the connection means 74 and the mating connection means are permanently attached to the vertical mounting members 66 and 68 and the mask members 48 and 50, respectively, they must each extend a minimum distance from the ends to insure that a portion will still be present for the smallest size television on which the mask assembly is intended for use even after the elements of the mask assembly 46 are cut to size.

In the event, after the mask assembly 46 has been cut to size and a portion of the connection means 78 and 80 is covering the remote control sensor, and they are not infrared transparent, then that portion of the connection means is removed to form a window for passage of the infrared remote control signals. Alternatively, in the case of VELCRO-like fasteners, or other types of fasteners, pinholes may be added throughout their location to insure infrared light transmission to the sensor regardless of where the connection means 78 and 80 are located.

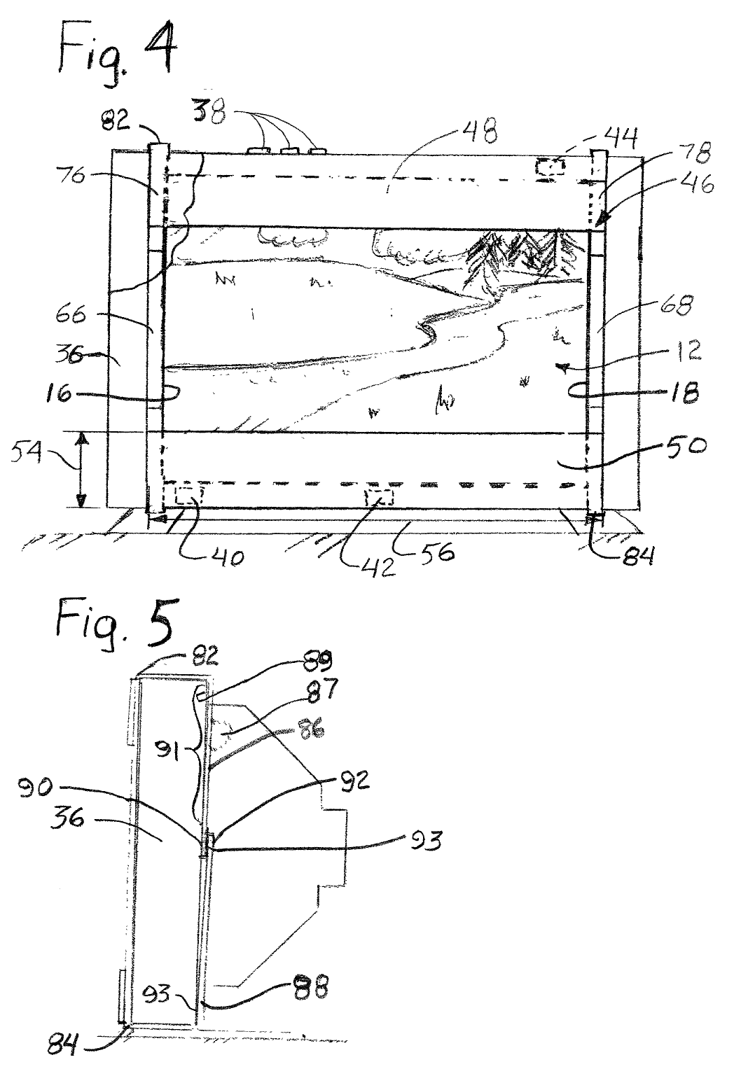

Referring now to FIGS. 4 and 5, an alternative embodiment of the invention is shown in which the vertical mounting members 66 and 68 are removably mounted to the display screen housing 36 rather than being relatively permanently mounted by means of non-drying adhesive or the like as described above with respect to FIGS. 2 and 3 Instead, the opposed ends 82 and 84 of the vertical mounting members 66 and 68 are attached to each other to form a loop surrounding the display screen 12 from front to back. A pair of elongate vertical attachment members 86 and 88 is respectively attached to the ends 82 and 84 of the vertical mounting members 66 and 68. In turn, the opposed ends 90 and 92 are attached to each other behind the display screen housing 36. The opposed ends 90 and 92 are releasably secured to each other by means of a suitable releasable fastener 93, which can be a VELCRO-like fastener.

Alternatively, the attachment members are permanently attached to each other, or are integrally formed together, and are, themselves, resilient to easily mount the vertical mounting members to the display screen 36. The members 90 and 92 extend around the display screen housing 36 between the bottom and the top adjacent the opposite sides of the display screen housing 36, respectively, preferably with the vertical mounting members located parallel to and adjacent to the sides of the display screen 16 and 18.

Referring to FIG. 5, alternatively, the lower members 88 are eliminated, and a weight pocket 87, shown in broken line, containing a flexible weight, such as a bag of sand or the like, is added to an upper back portion of the upper members 86. The weight pocket hangs over the back of the display screen to provide a counter-weight for the portion extending downwardly along the front of the display screen and the frame members 66 and 68 that they support. This like the vertical loop mounting, this alternative mounting also has the relative advantage of not requiring any VELCRO or other fastener to be permanently attached to the display screen housing.

Alternatively, instead of a weight pocket 87, a relatively small piece of VELCRO is adhesively attached to the back side of the display screen housing adjacent the top at the location indicated by reference numeral 89. An elongate mating piece of VELCRO is attached to the inside surface of the member 86 at the location indicated by reference numeral 91 to releasably suspend the front portions of the members 86 and the frame members 66 and 68 that they support. The length of the VELCRO-like fastener at 91 enables adjustment. While this mounting method requires a semi-permanent attachment of the VELCRO-like fasteners, because the fasteners are at the back of the display screen they are not visible from the front. The attachment members 86 are draped over the top and again suspended from the top of the display screen housing as in the mounting technique using the counterweight described above.

Alternatively, if desired for a neater appearance, the suspended vertical members 86 can be tucked underneath the bottom of the display screen housing or attached to the back of the housing at 93 with a mating pair of VELCRO-like fasteners.

Regardless of the manner in which the vertical attachment members 86 are mounted, The mask members 48 and 50 are removably mounted, or releasably attached, to the vertical attachment members 66 and 68 by the same releasable attachment means as described above with respect to FIGS. 2 and 3, such as VELCRO-like fasteners, with the bodies of the mask members 48 and 50 extending across the display screen 12 in a position to mask the inactive portions 24 and 26 of the display screen 12.

While the entire length of the attachment members need not be resilient but preferably at least a portion of each of the attachment members 86 and 88 mask members is resilient, even when the formed of two separate pieces that are joined at their ends 90 and 92 in order to facilitate a snug fit with the display screen housing 36.

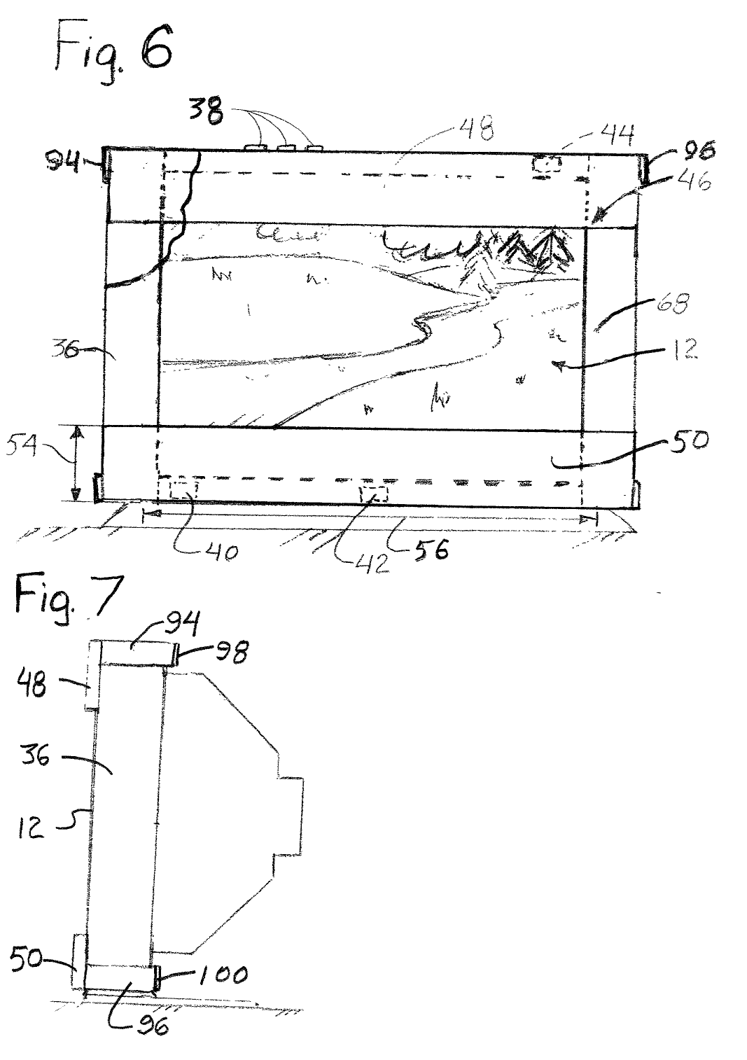

Referring now to FIGS. 6 and 7, another form of the mask assembly is shown in which the vertical frame-mounting members 66 and 68 have been eliminated entirely. While this also eliminates the mask assembly from forming a rectangular frame of the entire letterbox picture, it also eliminates the need for permanent attachment of any of the elements to the display screen housing 36. Instead, means for mounting the mask members 48 and 50 to the display screen housing 36 are provided by loop members 94 and 96 respectively connected to opposite ends of the horizontal mask members 48 and 50 to form a horizontal loop around the display screen housing 36. Preferably, the horizontal loop formed by the loop members at least partly formed by means including a resilient member to facilitate a snug fit. Preferably each of the loop members 94 and 96 are formed of two parts that are releasably secured together by releasable fastener 98 and 100, respectively, for selectively opening the loops to dismount the associated mask members 48 and 50 from the display screen housing.

Thus, it is seen from the above that the invention includes a method of watching a program displayed in letterbox dimensions on a display screen having non-letterbox dimensions and a remote control sensor and circuit responsive to signals received at the remote control sensor to control one or more functions associated with the display screen. This method is achieved by performing the steps of (1) mounting an infrared remote control transparent but relatively visually opaque mask member to the display screen to cover a non-active portion of the screen and the remote control sensor, (2) blocking substantially all reflective light from the non-active portion of the screen with the visually opaque mask member, and (3) remotely controlling the display screen with infrared remote control signals that pass through the mask member to the remote control sensor.

The invention also includes a method of masking the non-active portions of a display screen of non-letter box dimensions when displaying a letterbox dimensioned program by performing the steps of (1) mounting a pair of elongate, generally rectangular, vertical mounting frame members adjacent to and parallel to opposite sides of the display screen but not overlying any portion of the display screen by means that is covered by the vertical frame members for the display screen from at least the top to the bottom of the display screen, and (2) mounting a pair of mask members to horizontally extend across the display screen by attaching opposed ends of the mask members to the pair of vertical mounting frame members, respectively, to cover upper and lower non-active portions of the display screen and defining horizontal frame members for the screen. This method includes the step of cutting the mask members to terminate at the juncture with the mounting frame members after the mask members are mounted, and making the vertical mounting members that appears substantially the same as the material of the mask members to provide a uniform appearance.

While a particular embodiment of the mask assembly has been disclosed in detail, it should be appreciated that many variations may be made without departing from the spiriti of the invention as set forth in the appended claims. For instance, while not preferred, in lieu of the entire mask members 48 and 50 being infrared transparent, if only a window of infrared transparent material is included a composite mask member made of both transparent and non-infrared transparent material, then the visibly transparent window is selectively located to be positioned in front of the remote control sensor when the mask member is mounted to the screen. Also, the frame-mounting members need not extend the full length of the screen but instead my be replaced by two shorter lengths equal to the thickness of the mask members that are located adjacent the top and the bottom of the screen and entirely covered by the mask members for an appearance similar to that shown in FIGS. 6 and 7.

1. An adjustable mask assembly for masking an inactive portion of display screen with non-letterbox dimensions when showing a program in letterbox format, comprising:
a masking member for covering the inactive portion of the display screen and capable of passing remote control light signals for controlling the operation of the display screen; and
means for removably mounting the remote control, light signal passing, masking member to the display screen to mask the inactive portion of the display screen.

2. The adjustable mask assembly of claim 1 in which
the display screen is part of a display screen assembly that includes a display screen housing to which is mounted a remote control sensor responsive to remote control light signals and a circuit for responding to remote control light signals sensed by the remote control sensor,
the masking member has at least a part that is sufficiently transparent to remote control light signals to enable such remote control signals to pass through to be sensed by the remote control signal sensor, and
means for mounting the at least part of the masking member in a position overlying the remote control sensor.

3. The adjustable mask assembly of claim 2 in which
only a part of the masking member is sufficiently transparent to remote control signals to enable sensing by the remote control sensor, and
the means for removably mounting includes means for mounting said transparent part in a position overlying the remote control sensor.

4. The adjustable mask assembly of claim 3 including means for selectively moving the relative position of the sufficiently transparent part with respect to the ends of the masking member to position the part in a position overlying the remote control sensor.

5. The adjustable mask assembly of claim 2 in which substantially the entire masking member is sufficiently transparent to remote control signals to enable sensing by the remote control sensor.

6. The adjustable mask assembly of claim 1 in which at least the part is made of material with a myriad of small openings that are relatively invisible to normal unaided observation by viewers of the display when the part is backed against a dark surface of an inactive portion of the display screen.

7. The adjustable mask assembly of claim 6 in which the material is a cloth-like material mounted to transparent plastic material.

8. The adjustable mask assembly of claim 6 in which the cloth-like material is felt.

9. The adjustable mask assembly of claim 8 in which the felt has a weight or grade of 5-ounces per square yard and a thickness of 1/16^{th} inch.

10. The adjustable mask assembly of claim 6 in which the material is a synthetic.

11. The adjustable mask assembly of claim 1 in which at least the part is an infrared light transparent window selectively located to be positioned in front of the remote control sensor.

12. The adjustable mask assembly of claim 1 in combination with a display screen having a remote control sensor, and in which the mask member is in a position covering the remote control sensor.

13. The adjustable mask assembly of claim 1 including
a pair of elongate mounting members having a length sufficient to span the display screen from top to bottom when adjacent to and parallel to one of the opposites sides of the display screen and having a front and a back,
means carried on the back to attach the mounting member to the display screen housing adjacent to and in parallel relationship with one of the opposite sides of the display screen, and
means carried on the front of the vertical mask member for releasable connection with an end portion of a horizontal masking member for support of the masking member between the pair of mounting members in a position to mask an inactive portion of the display screen.

14. The adjustable mask assembly of claim 1 including
a pair of elongate mounting members having a length sufficient to span the display screen from top to bottom when adjacent to and parallel to one of the opposites sides of the display screen and having a front and a back,
means for releasably securing opposed ends of each of the elongate mounting members to form a loop surrounding the display screen front to back; and
means for mounting the opposite ends of the elongate masking member to the pair of vertical members with the body extending across the display screen in a position to mask the inactive portion of the screen.

15. The adjustable mask assembly of claim 1 in which the mask member has a pair of opposed ends and including means for securing the opposed ends together to form a generally horizontal loop surrounding the display screen front to back.

16. The adjustable mask assembly of claim 15 in which at least a portion of the securing means includes a resilient member.

17. The adjustable mask assembly of claim 15 in which the securing means includes
a pair of attaching members respectively connected to the opposed ends of the mask member, and
a fastener for releasably attaching together attaching members opposite ends of the mask member to for a loop that surrounds the display screen.

18. An adjustable mask assembly for masking an inactive portion of a display screen of non-letterbox dimension when showing a program in letterbox format and being mounted within a display screen housing having a pair of opposite sides extending between a bottom and a top, comprising:
an elongate masking member for covering the inactive portion of the display screen having a body extending between a pair of opposite ends;
a pair of elongate vertical frame mounting members mounted adjacent to and generally parallel to the pair of opposite sides of the display screen housing, respectively, each of the vertical frame mounting members having an elongate frame body that spans the entire side of the display screen and carrying means for attachment of the body to the display screen housing, said attachment means being covered from view by the body when attached to the display screen body; and
means for mounting the opposite ends of the elongate masking member to the pair of vertical frame members with the body extending across the display screen in a position to mask the inactive portion of the screen.

19. The adjustable mask assembly of claim 18 in which each of the pair of elongate vertical frame members is mounted to the television adjacent to one of the pair of sides of the display screen by means of one of (a) adhesive or (b) a permanent magnet.

20. The adjustable mask assembly of claim 18 in which at least a part of the mask member is made of infrared remote control transparent material that appears opaque in the visible spectrum when not backlit.

22. The adjustable mask assembly of claim 18 in which the mask member is made of dark colored felt that is transparent to infrared remote control signals.

23. An adjustable mask assembly for masking an inactive portion of a display screen of non-letterbox dimension when showing a program in letterbox format and being mounted within a a display screen housing having a pair of sides extending between a top adjacent and parallel to a pair of opposite sides of the display screen and a bottom, comprising:
a pair of elongate frame mounting members attached to the display screen housing by a vertical loop surrounding the display screen housing from top to bottom with a frame body located adjacent to an parallel to the pair of sides of the display screen;
means carried by the body of each of the pair of elongate frame mounting members for releasable connection with an end portion of a horizontal mask member; and
a pair of horizontal mask members with a pair of opposed end portions having releasable connectors for releasable connection with releasable connection means of the elongate frame mounting members for support of the horizontal mask member in a position to mask an inactive portion of the display screen

24. The adjustable mask assembly of claim 23 in which the vertical loop is formed by means including a resilient member.

25. The adjustable mask assembly of claim 24 in which the vertical loop is formed by means including a releasable fastener for selectively opening the loop to dismount the body of the frame mounting member from the display screen housing.

26. The adjustable mask assembly of claim 23 in which each of the mask members is made of felt having a weight of approximately 5-ounces per square yard and a thickness of approximately 1/16^{th} inch.

27. The adjustable mask assembly of claim 23 in which the mask member is at least partially made of infrared remote control signal transparent material.

28. An adjustable mask assembly for masking an inactive portion of a display screen of non-letterbox dimension when showing a program in letterbox format and being mounted within a display screen housing having a pair of sides extending between a top adjacent and parallel to a pair of opposite sides of the display screen and a bottom, comprising:
a pair of horizontal mask members for masking a pair of inactive portions of the display screen, and
means for mounting the mask member to the display screen housing including means connected to opposite ends of the horizontal mask members to form a horizontal loop around the display screen housing.

29. The adjustable mask assembly of claim 28 in which the horizontal loop is formed by means including a resilient member.

30. The adjustable mask assembly of claim 28 in which the horizontal loop is formed by means including a releasable fastener for selectively opening the loop to dismount the mask member from the display screen housing.

31. The adjustable mask assembly of claim 28 in which each of the mask members is made of felt having a weight of approximately 5-ounces per square yard and a thickness of approximately 1/16^{th} inch.

32. The adjustable mask assembly of claim 28 in which each of the mask members is at least partially made of infrared remote control signal transparent material.

33. A method of watching a program displayed in letterbox dimensions on a display screen having non-letterbox dimensions and a remote control sensor and circuit responsive to signals received at the remote control sensor to control one or more functions associated with the display screen, comprising the steps of:
mounting an infrared remote control transparent but relatively visually opaque mask member to the display screen to cover a non-active portion of the screen and the remote control sensor;
blocking substantially all reflective light from the non-active portion of the screen with the visually opaque mask member;
remotely controlling the display screen with infrared remote control signals that pass through the mask member to the remote control sensor.

34. The method of claim 33 in which the remote control transparent mask member is made of felt.

35. The method of claim 33 in which the felt has a weight of approximately 5-ounces per square yard and thickness of approximately 1/16^{th} inch.

36. A method of masking the non-active portions of a display screen of non-letter box dimensions when displaying a letterbox dimensioned program, comprising the steps of:
mounting a pair of elongate, generally rectangular, vertical mounting frame members adjacent to and parallel to opposite sides of the display screen but not overlying any portion of the display screen by means that is covered by the vertical frame members, said vertical mounting members spanning the display screen from at least the top to the bottom of the display screen; and
mounting a pair of mask members horizontally across the display screen by attaching opposed ends of the mask members to the pair of vertical mounting frame members, respectively, to cover upper and lower non-active portions of the display screen and defining horizontal frame members for the screen.

37. The method of claim 36 including the step of cutting the mask members to terminate at the juncture with the mounting frame members after the mask members are mounted.

38. The method of claim 36 in which the vertical mounting members are made of substantially the same material as that of the mask members to provide a uniform appearance.
